(19) United States
(12) Patent Application Publication
(10) Pub. No.: US 2018/0281949 A1
(43) Pub. Date: Oct. 4, 2018

(54) SYSTEMS AND METHODS FOR STABILISATION OF AERIAL VEHICLES

(71) Applicant: Altus Ip Limited, Hamilton (NZ)

(72) Inventor: Shaun Gordon MITCHELL, Hamilton (NZ)

(21) Appl. No.: 15/758,888

(22) PCT Filed: Sep. 8, 2016
(86) PCT No.: PCT/NZ2016/050142

§ 371 Date: Mar. 9, 2018

(30) Foreign Application Priority Data
Sep. 9, 2015 (NZ) 712108

(51) Int. Cl. B64C 39/02; B64C 11/48; B64C 17/00; B64C 27/10; B64C 27/32

(52) U.S. Cl. CPC B64C 39/024; B64C 11/48; B64C 17/00; B64C 2201/14; B64C 27/32; B64C 2201/027; B64C 2201/108; B64C 27/10

(57) ABSTRACT

A rotor assembly for a multirotor aircraft, and a multirotor aircraft, are disclosed herein. The rotor assembly has a first motor having a first axis of rotation and a first propeller connected to the first motor. The rotor assembly has a second motor having a second axis of rotation, and a second propeller connected to the second motor. The second propeller is smaller in length than the first propeller. The first motor and the first propeller produce a greater proportion of a total lift thrust of the rotor assembly than the second motor and the second propeller. The multirotor aircraft includes an airframe and a plurality of the rotor assemblies mounted to the airframe.

### TECHNICAL FIELD

The present disclosure relates to aerial vehicles, more particularly unmanned multirotor rotorcraft, and rotor assemblies, systems, and methods for their stabilisation in flight.

### STATEMENT OF CORRESPONDING APPLICATIONS

This application is based on the provisional specification filed in relation to New Zealand Patent Application Number 712108, the entire contents of which are incorporated herein by reference.

### BACKGROUND

Unmanned aerial vehicles (UAVs), particularly rotorcraft, are increasingly being deployed in a wide range of applications, including: industrial surveying, construction, mining, stockpiling, photogrammetry, aerial photography, cinematography and video, live streaming, newsgathering, multispectral analysis for vegetation, security and surveillance, asset inspection, transmission and pipeline inspection.

It is generally desirable to increase the flight time of a UAV while carrying a payload (such as an imaging device), and thereby improve operational efficiency—i.e. allowing a task to be completed without the interruption of requiring the UAV to return and land for recharging or replacement of its power source.

One technique for improving flight time is to increase the size of the propellers. Put simply, bigger propellers have less drag for a given thrust, and as such are more power efficient and allow for longer flight times.

However, in the case of multirotor UAVs, stabilization is achieved by adjustment of the thrust of each rotor. Where fixed-pitch propellers are used, this thrust adjustment is achieved through controlling the speed of rotation of the propeller. Larger propellers are harder to speed up and slow down quickly in comparison with smaller propellers, due to their rotational mass and are therefore often too slow to react to inputs from the autopilot resulting in an unstable aircraft particularly in windy conditions.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### SUMMARY OF DISCLOSURE

According to one aspect of the present disclosure there is provided a rotor assembly for a multirotor aircraft. The rotor assembly may include a first motor having a first axis of rotation. The rotor assembly may include a first propeller connected to the first motor. The rotor assembly may include a second motor having a second axis of rotation. The rotor assembly may include a second propeller connected to the second motor. The second propeller may be smaller in length than the first propeller. The first motor and the first propeller may produce a greater proportion of a total lift thrust of the rotor assembly than the second motor and the second propeller.

According to another aspect of the present disclosure there is provided a multirotor aircraft. The multirotor aircraft may include an airframe. The multirotor aircraft may include a plurality of rotor assemblies mounted to the airframe. Each rotor assembly may include a first motor having a first axis of rotation. Each rotor assembly may include a first propeller connected to the first motor. Each rotor assembly may include a second motor having a second axis of rotation. Each rotor assembly may include a second propeller connected to the second motor. The second propeller of each rotor assembly may be smaller in length than the first propeller. The first motor and the first propeller of each rotor assembly may produce a greater proportion of a total lift thrust of the rotor assembly than the second motor and the second propeller of the rotor assembly.

According to an aspect of the present disclosure there is provided a method of operating a multirotor aircraft including an airframe, and a plurality of rotor assemblies mounted to the airframe, each rotor assembly including a first motor having a first axis of rotation with a first propeller connected to the first motor, and a second motor having a second axis of rotation and a second propeller connected to the second motor, wherein the second propeller is smaller in length than the first propeller. The method may include controlling the first motor and the second motor of each rotor assembly such that the first motor and the first propeller produce a greater proportion of a total lift thrust of the rotor assembly than the second motor and the second propeller of the rotor assembly.

Reference to a multirotor aircraft should be understood to mean a rotorcraft—i.e. an aircraft in which lift is generated by rotors (vertically oriented propellers)—having more than two sets of rotors. It is envisaged that the present disclosure may have particular application to unmanned aerial vehicles (UAV) with a fixed-pitch multirotor configuration—i.e. the pitch of the propellers is constant, in comparison with variable pitch rotors in which the pitch may be adjusted to assist with stabilizing the aircraft.

The airframe of a multirotor aircraft provides the supporting structure for the craft. The airframe typically includes a central hull from which arms or booms extend, with the motors mounted to the booms.

Numerous configurations for multirotor aircraft using pairs of propellers are known in the art, commonly referred to by the number of propellers and the arrangement of arms or booms extending from the hull of the airframe. For example, a tri-armed UAV with a pair of motors and propellers on each arm may be referred to as having a “Y6” configuration, while a four-armed configuration may be referred to as having an “X8” configuration. X12 (i.e. six-armed) and X16 (i.e. eight-armed) configurations are also known, among others. While exemplary embodiments of the present disclosure may be discussed with reference to an X8 configuration, it should be appreciated that this is for ease of explanation and is not intended to be limiting unless explicitly stated.

The multirotor aircraft may include a control system for performing automated functions—for example stabilization of the multirotor aircraft by controlling the lift thrust of the respective rotor assemblies.

The control system may include devices as known in the art for flight control (and more particularly autopilot functionality), for example: a controller having at least one processor, wireless communication devices for communication with a ground control station, location determination devices (for example, one or more GPS units), inertial measurement units (IMUS)—whether integrated or having distinct sensors such as accelerometers, gyroscopes, pressure sensors, and/or magnetometers—or any other desirable feature. By way of example, the control system may include a flight controller such as the “Gemini M (Gemini S)” flight controller supplied by Zero UAV (Beijing) Intelligence Technology Co., Ltd at the time of filing the application or the “Cerberus-R” flight controller supplied by InnoFlight Ltd at the time of filing the application.

The control system may be configured to stabilize the aircraft in terms of correcting undesired deviation in roll, pitch, or yaw. In a fixed-pitch multirotor aircraft, this necessitates controlling the thrust of one or more of the rotor assemblies—for example using a feedback loop based on PID control. In an exemplary embodiment, each of the motors in each rotor assembly may be controlled individually to achieve stable flight and flight direction. Altering the speed of each motor allows for control of the aircraft's yaw and pitch in different directions. This utilizes the motor redundancy created by the configuration described to reduce the effect of compromises between larger propellers and smaller propellers on multirotor UAV's.

Generally speaking, larger propellers can spin at lower RPM's and are more efficient in terms of producing a greater level of thrust for power consumption. The compromise is that the larger propellers react more slowly and therefore create a level of instability for a multirotor UAV. The prior art has attempted to correct for this through faster reacting speed controllers and speed controllers with active braking, but these are not extremely effective and do not completely overcome the issue of stability—in addition to drawbacks with regard to expense and other compromises in terms of complexity, and size and weight.

Smaller propellers alternatively require more power to produce the same amount of thrust, but are able to react to controller inputs very quickly due to lower rotational mass, and spin at much higher RPMs. This creates a very stable system, but with a compromise in efficiency and therefore flight times.

Bringing these two propeller technologies together allows for the compromises of each to be balanced. In simple terms, the large propeller is configured to do a larger proportion of the lifting of the aircraft at a higher efficiency. The smaller propeller—spinning faster, with a lower lift load—fills in the gaps of the larger propeller system in terms of stability, therefore creating a stable and efficient platform.

Achieving this harmony requires effective integration of thrust calculations, and may require a unique coding for the controller for it to best utilize each of the components. In an exemplary embodiments: the first and second motors may be controlled separately by the controller. Generally, the larger propellers must do as much of the thrust lifting as possible, have a lower throttle sensitivity to the smaller propeller and motor combination, and have less sensitivity to sway and roll—with reaction essentially reduced to best fit with the larger propeller's capability and strengths. The smaller prop motors may be configured in an opposite manner, i.e. they may have a higher throttle sensitivity, and have a high sensitivity to sway and roll while producing the lowest or minimum amount of thrust possible—again leveraging the small propeller's capabilities and strengths.

In an exemplary embodiment the first motor and the first propeller of each rotor assembly may be configured to produce between about 55 to 75 percent of the total lift thrust of the rotor assembly, and the second motor and the second propeller may be configured to produce between about 45 to 25 percent of the total lift thrust. In an exemplary embodiment the first motor and the first propeller of each rotor assembly may be configured to produce between about 55 to 65 percent of the total lift thrust of the rotor assembly, and the second motor and the second propeller may be configured to produce between about 45 to 35 percent of the total lift thrust.

This thrust range is that of the total lift thrust required to achieve hover flight. It is envisaged that most UAV configurations will be capable of hovering at 50% or less of the thrust capability of the motor and propeller combination selected for the aircraft for efficiency purposes—although it should be appreciated that this is not intended to be limiting.

It should be appreciated that the contribution of the respective motors and propellers to the total lift thrust may be achieved in a variety of ways. Factors contributing to thrust include properties of the propellers such as propeller length and pitch, as well as characteristics of the motor such as the motor velocity constant.

In an exemplary embodiment, the motor velocity constant of the first motor may be smaller than that of the second motor. For example, the first motor may have a motor velocity constant of 170 KV and the second motor may have a motor velocity constant of 340 KV (KV denoting the revolutions per minute that a motor will turn when a 1 V potential difference is applied with zero load). It should be appreciated that these values are given by way of example, and are not intended to be limiting to all embodiments.

In an exemplary embodiment, it is envisaged that the first motors may be controlled by a first control loop, and the second motors may be controlled by a second control loop. In such an arrangement, the control of the two sets of motors (i.e. the first motors and the second motors) may be tuned separately to each other. This enables the fine tuning of the control loops specific to the desired role that the motor and propeller combination will perform, bypassing the requirements to make compromises during tuning of the control loops to accommodate both motor and propeller combinations equally. In comparison, where each rotor assembly (i.e. a first motor and a second motor) are controlled as a single motor, the ability to achieve a desired specification in terms of flight time versus stability may be more heavily reliant on the selection of the technical specifications of the motors and propellers.

In an exemplary embodiment, the first axis of rotation of the first motor of each rotor assembly may be coaxial with the second axis of rotation with the second motor of the rotor assembly.

According to one aspect of the present disclosure there is provided a rotor assembly for a multirotor aircraft. The rotor assembly may include a first motor having a first axis of rotation. The rotor assembly may include a first propeller connected to the first motor. The rotor assembly may include a second motor having a second axis of rotation coaxial with the first axis of the first motor. The rotor assembly may include a second propeller connected to the second motor, wherein the second propeller is smaller in length than the first propeller. The first motor and the first propeller may produce a greater proportion of a total lift thrust of the rotor assembly than the second motor and the second propeller.

According to another aspect of the present disclosure there is provided a multirotor aircraft. The multirotor aircraft may include an airframe. The multirotor aircraft may include a plurality of rotor assemblies mounted to the airframe. Each rotor assembly may include a first motor having a first axis of rotation. Each rotor assembly may include a first propeller connected to the first motor. Each rotor assembly may include a second motor having a second axis of rotation coaxial with the first axis of the first motor. Each rotor assembly may include a second propeller connected to the second motor, wherein the second propeller is smaller in length than the first propeller. The first motor and the first propeller of each rotor assembly may produce a greater proportion of a total lift thrust of the rotor assembly than the second motor and the second propeller.

According to an aspect of the present disclosure there is provided a method of operating a multirotor aircraft including an airframe, and a plurality of rotor assemblies mounted to the airframe, each rotor assembly including a first motor having a first axis of rotation with a first propeller connected to the first motor, and a second motor having a second axis of rotation coaxial with the first axis of the first motor and a second propeller connected to the second motor, wherein the second propeller is smaller in length than the first propeller. The method may include the step of controlling the first motor and the second motor such that the first motor and the first propeller produce a greater proportion of a total lift thrust of the rotor assembly than the second motor and the second propeller.

In an exemplary embodiment, the first axis of rotation of the first motor of each rotor assembly may be laterally offset from the second axis of rotation with the second motor of the rotor assembly. In an exemplary embodiment the first motor and first propeller of each rotor assembly may be positioned further from a centre of the airframe than the second motor and second propeller. By positioning the first motor and first propeller (i.e. the larger propeller) further from the centre, it is envisaged that the footprint may be contained in comparison with embodiments of a revise configuration with the same offset and propeller sizing. However, it should be appreciated that exemplary embodiments are contemplated in which the second motor and second propeller of each rotor assembly may be positioned further from a centre of the airframe than the first motor and first propeller.

In exemplary embodiments in which the airframe includes booms to which the motors are mounted, the lateral offset between the first and second motors may be achieved by spacing the motors apart along a boom. In an exemplary embodiment the airframe may include a plurality of shrouds in one or more booms within which the motors are received.

In an exemplary embodiment, the first motor and the first propeller (i.e. the larger propeller) may be positioned above the second motor and the second propeller (i.e. the smaller propeller). It is envisaged that this may assist in the packing and transportation of the UAV. Further, it is believed that by positioning the larger propeller above (which spins at a slower revolution rate relative to the smaller propeller), the variation in the vortex airflow produced is less disturbing to the effectiveness of the second propeller than configurations in which the upper and lower motors and propellers are essentially matched. However, it should be appreciated that this is not intended to be limiting, and in an exemplary embodiment, the first motor and the first propeller may be positioned below the second motor and the second propeller.

In an exemplary embodiment the first motor and the second motor of each rotor assembly may be configured to counter-rotate. However, it should be appreciated that this is not intended to be limiting, and in exemplary embodiments the first motor and the second motor of each rotor assembly may rotate in the same direction.

In an exemplary embodiment, the first motors of adjacent rotor assemblies may be configured to counter-rotate. It is envisaged that this may assist in countering the yawing effect of the larger propellers, which is more pronounced than that of the smaller propellers.

In an exemplary embodiment, the first propeller and the second propeller may have a different number of blades. In an exemplary embodiment the first propeller may have more blades than the second propeller. In an exemplary embodiment the first propeller may have more than two blades. For example, the first propeller may be a three blade propeller, and the second propeller may be a two blade propeller.

By using a first propeller with more blades, the propeller wash of the first propeller may have a wave frequency offset from that of the second propeller. It is envisaged that this may improve the “bite” of a propeller within the wash of the other propeller in order to improve the effectiveness of that propeller and motor—for example the second propeller, where the second propeller is below the first propeller. Further, it is envisaged that in a multirotor UAV, a first propeller with more than two blades may allow a smaller diameter propeller to be used—with improved responsiveness in comparison with a larger two blade, although potentially with some reduced power efficiency for comparable thrust.

For completeness, it should be appreciated that reference to the first propeller and the second propeller having a different number of blades is not intended to be limiting to all embodiments of the present disclosure.

For a firmware and/or software (also known as a computer program) implementation, the techniques of the present disclosure may be implemented as instructions (for example, procedures, functions, and so on) that perform the functions described. It should be appreciated that the present disclosure is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor.

A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration.

The steps of a method, process, or algorithm described in connection with the present disclosure may be embodied directly in hardware, in a software module executed by one or more processors, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

### BRIEF DESCRIPTION OF THE DRAWINGS

Further aspects of the present invention will become apparent from the ensuing description which is given by way of example only and with reference to the accompanying drawings in which:

FIG. 1A is a side view of an exemplary multirotor aircraft according to an exemplary embodiment of the present disclosure;

FIG. 1B is a top view of the exemplary multirotor aircraft;

FIG. 1C is a side view of an exemplary rotor assembly for use with the exemplary multirotor aircraft;

FIG. 1D is a side view of another exemplary rotor assembly for use with the exemplary multirotor aircraft;

FIG. 2A is a top view of a second exemplary multirotor aircraft;

FIG. 2B is a side view of an exemplary rotor assembly for use with the second exemplary multirotor aircraft;

FIG. 3A is a schematic diagram of an exemplary flight system of the exemplary multirotor aircraft;

FIG. 3B is a schematic diagram of an exemplary flight controller of the exemplary multirotor aircraft;

FIG. 3C illustrates an exemplary ground control system in communication with the exemplary multirotor aircraft;

FIG. 4 is a flow diagram illustrating a method of stabilising the exemplary multirotor aircraft in flight, and

FIG. 5 is a graph of proportional thrust percentages and sensitivity settings of the exemplary rotor assembly.

### DETAILED DESCRIPTION

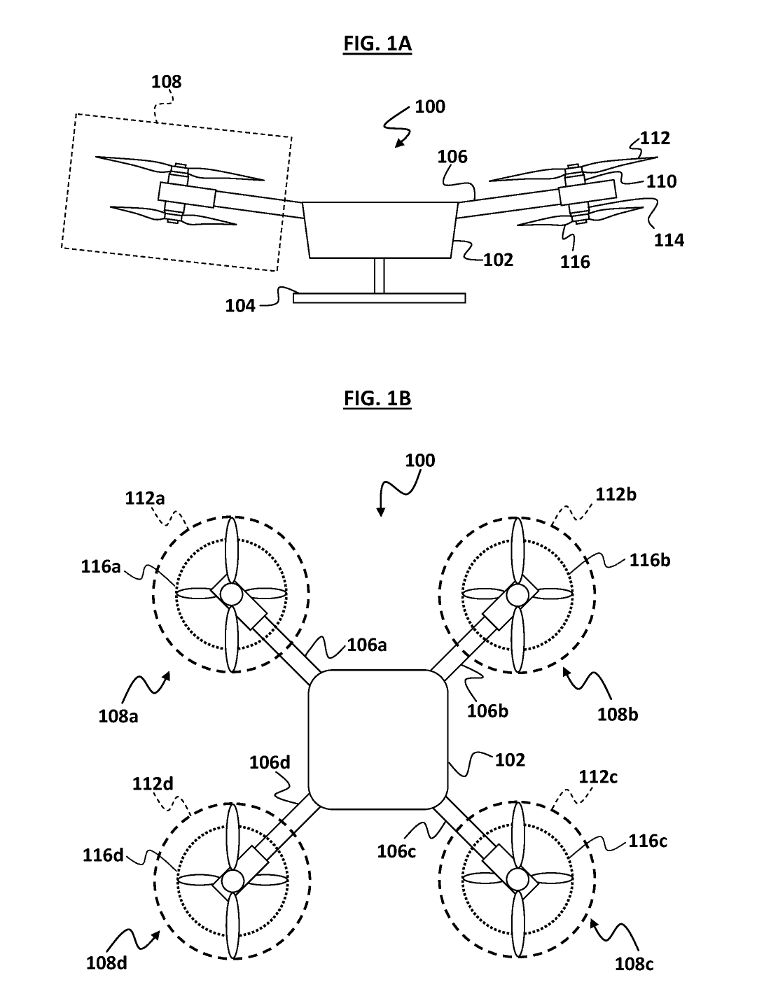

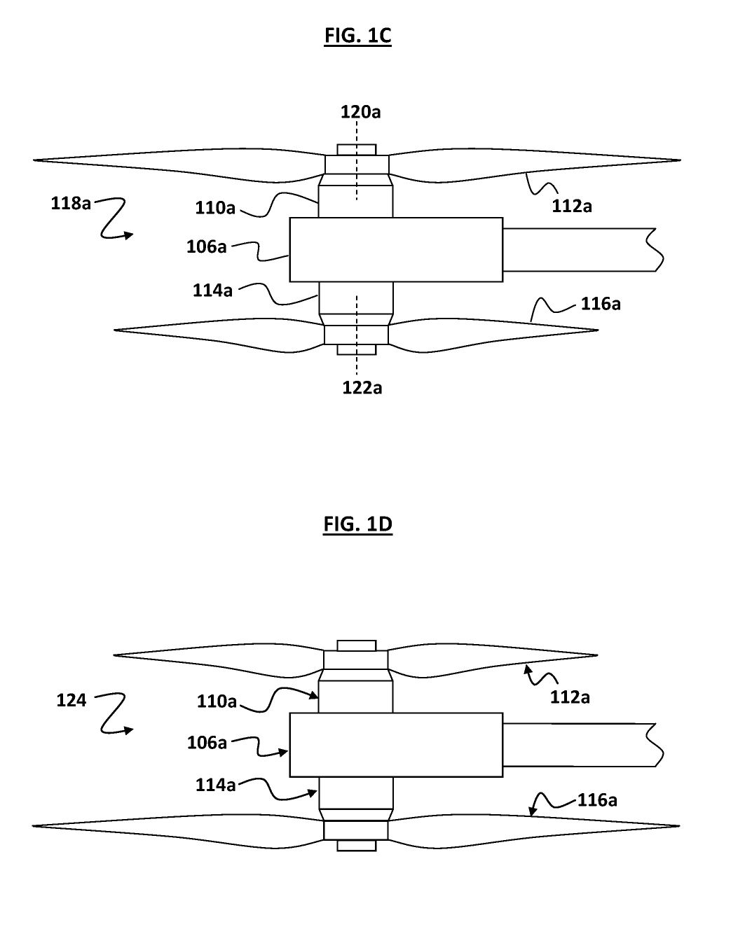

FIG. 1A and FIG. 1B illustrate an unmanned multirotor aircraft 100 in an “X8” configuration, herein referred to as “UAV 100”. As seen in FIG. 1A, the airframe of the UAV 100 includes a hull 102 supported by a landing base 104. Arms 106 (labelled arms 106a-d in FIG. 1B) extend from the hull 102, with rotor assemblies 108 (labelled rotor assemblies 108a-d in FIG. 1B) secured to the distal ends of the arms 106. It should be appreciated that while the arms 106 are illustrated as being pitched up from the hull 102, this is not intended to be limiting to all embodiments.

Each rotor assembly 108 includes a top motor 110 (labelled top motors 110a-d in FIG. 1B), to which a top propeller 112 (labelled top propellers 112a-d in FIG. 1B) is secured. Each rotor assembly 108 includes a bottom motor 114 (labelled bottom motors 114a-d in FIG. 1B), to which a bottom propeller 116 (labelled bottom propellers 116a-d in FIG. 1B) is secured. Referring to FIG. 1B, it may be seen that in this exemplary embodiment each of the rotor assembly 108a-d is equidistant from adjacent rotor assemblies.

FIG. 1C shows an exemplary rotor assembly configuration 118a for the UAV 100. In this exemplary embodiment the top motor 110a is a brushless DC motor having a motor velocity constant of 170 KV, with the top propeller 112a being a 28×8 two blade propeller (i.e. 28 inches in length or diameter, with a pitch of 8). The bottom motor 114a is a brushless DC motor having a motor velocity constant of 340 KV, with the bottom propeller 116a being 18×6.5. It should be appreciated that these values are given by way of example, and are not intended to be limiting to all embodiments subject of the present disclosure. In the configuration illustrated, the top axis of rotation 120a of the top motor 110a is substantially aligned with the bottom axis of rotation 122a of the bottom motor 114a—i.e. is co-axial.

In the case of a power supply in the form of a 6s battery (i.e. a six cell battery with a nominal voltage of 22.2V), the thrust values produced by each of the rotor assemblies 108a-d are outlined below in Table 1.

TABLE 1

| | | | | | % Overall |
|---|---|---|---|---|---|
| Motor | Power | Throttle | Thrust (g) | Prop RPM | thrust load |
| 170 kv | 6s | 50% | 1805 | 1650 | 57.67 |
| 340 kv | 6s | | 1325 | 3636 | 42.33 |
| 170 kv | 6s | 65% | 2780 | 2050 | 55.38 |
| 340 kv | 6s | | 2240 | 4641 | 44.62 |
| 170 kv | 6s | 75% | 3440 | 2250 | 54.82 |
| 340 kv | 6s | | 2835 | 5211 | 45.18 |
| 170 kv | 6s | 85% | 4140 | 2450 | 55.20 |
| 340 kv | 6s | | 3360 | 5628 | 44.80 |
| 170 kv | 6s | 100% | 4570 | 2620 | 52.50 |
| 340 kv | 6s | | 4135 | 6181 | 47.50 |

FIG. 1D shows an exemplary rotor assembly configuration 124 in which the characteristics of the top and bottom motors and propellers are switched in comparison with assembly 118a—i.e. the top motor 110a has a motor velocity constant of 340 KV with the top propeller 112a being 18×6.5, while the bottom motor 114a has a motor velocity constant of 170 KV, with the bottom propeller 116a being 28×8.

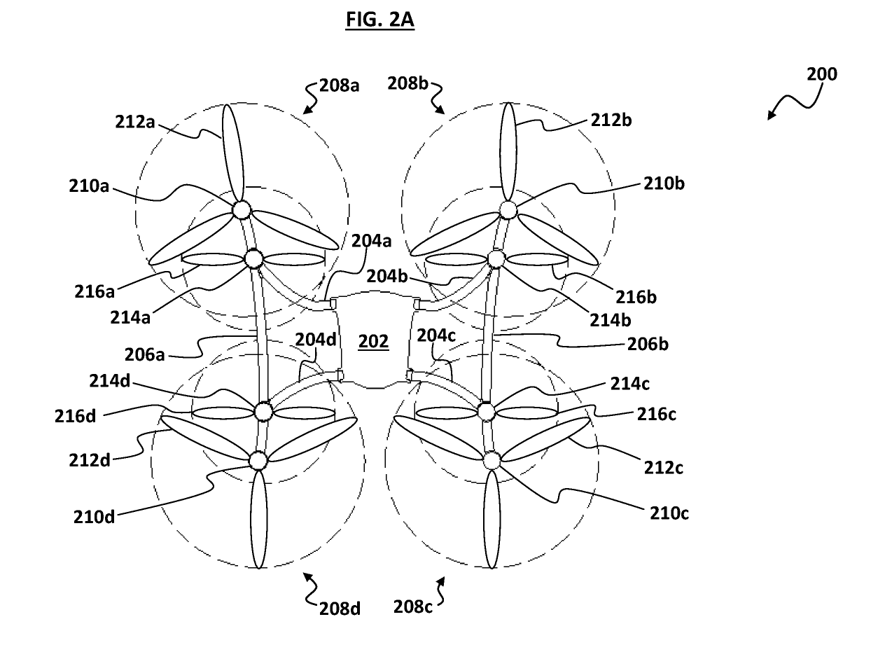

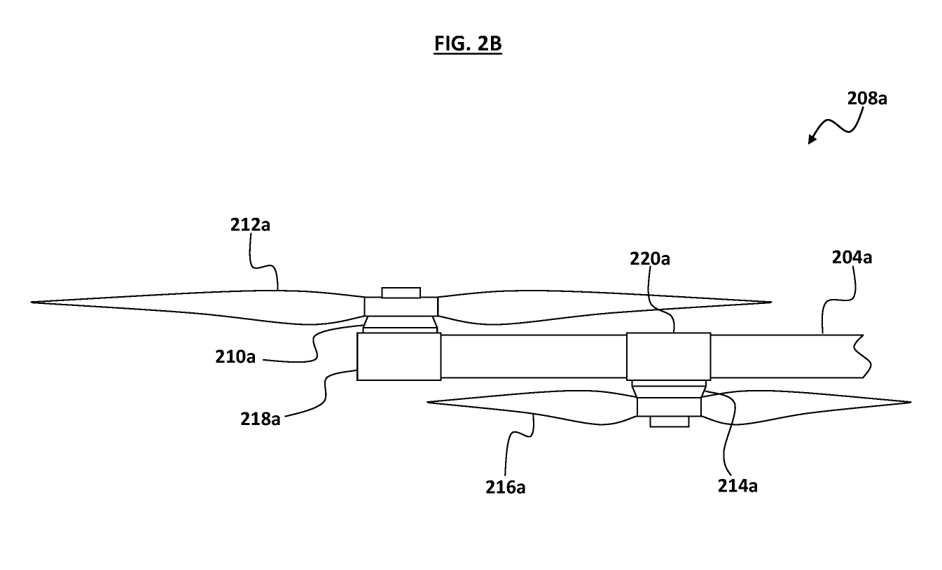

FIG. 2A illustrates a second exemplary unmanned multirotor aircraft 200, herein referred to as “UAV 200”. The airframe of the UAV 200 includes a hull 202 supported by a landing base (not illustrated, but refer to landing base 104 of FIG. 1A as an example). Arms 204a-d extend from the hull 202, having a first cross-brace 206a between arms 204a and 204b, and a second cross-brace 206b between arms 204b and 204c.

The UAV 200 includes four rotor assemblies 208a-d. Each rotor assembly 208a-d includes a top motor 210a-d, to which a top propeller 212a-d is secured. Each rotor assembly 208a-d includes a bottom motor 214a-d, to which a bottom propeller 116a-d is secured. The top motors 210a-d are laterally offset from the bottom motors 214a-d along the arms 204a-d, with the bottom motors 214a-d closer to the hull 202. As shown in FIG. 2B, the arm 204a includes a first shroud 218a in which the top motor 210a is received and mounted, and a second shroud 220a in which the bottom motor 214a is received and mounted.

Returning to FIG. 2A, in this exemplary embodiment each of the top propellers 212a-d are a 27.5×8.9 three blade propeller and each of the bottom propellers 216a-d are a 18.5×6.3 two blade propeller. In this exemplary embodiment the top motor 210a is a brushless DC motor having a motor velocity constant of 170 KV, and the bottom motor 214a is a brushless DC motor having a motor velocity constant of 340 KV. Again, it should be appreciated that these values are given by way of example, and are not intended to be limiting to all embodiments subject of the present disclosure.

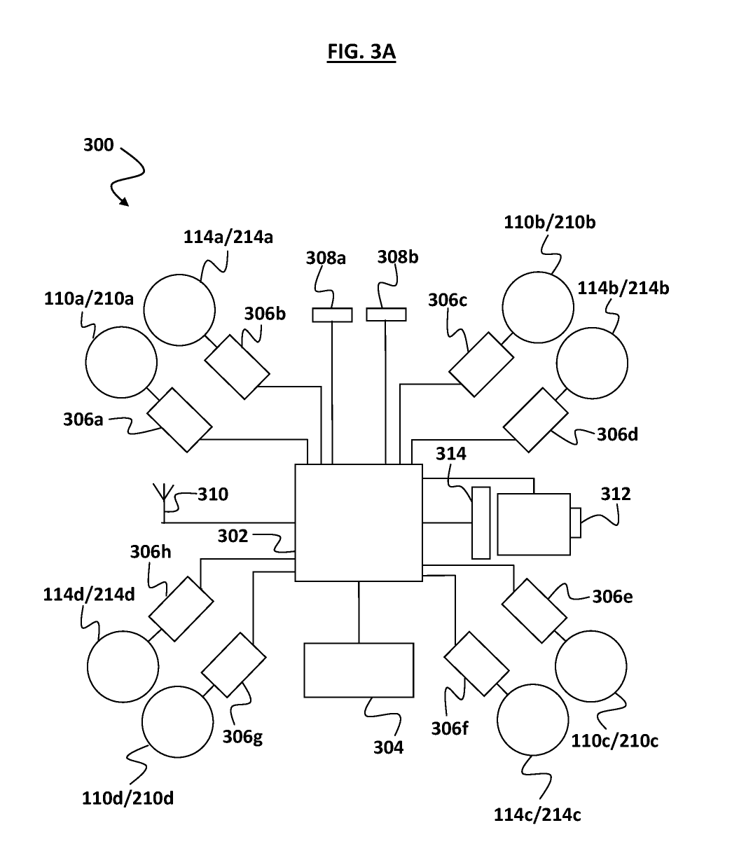

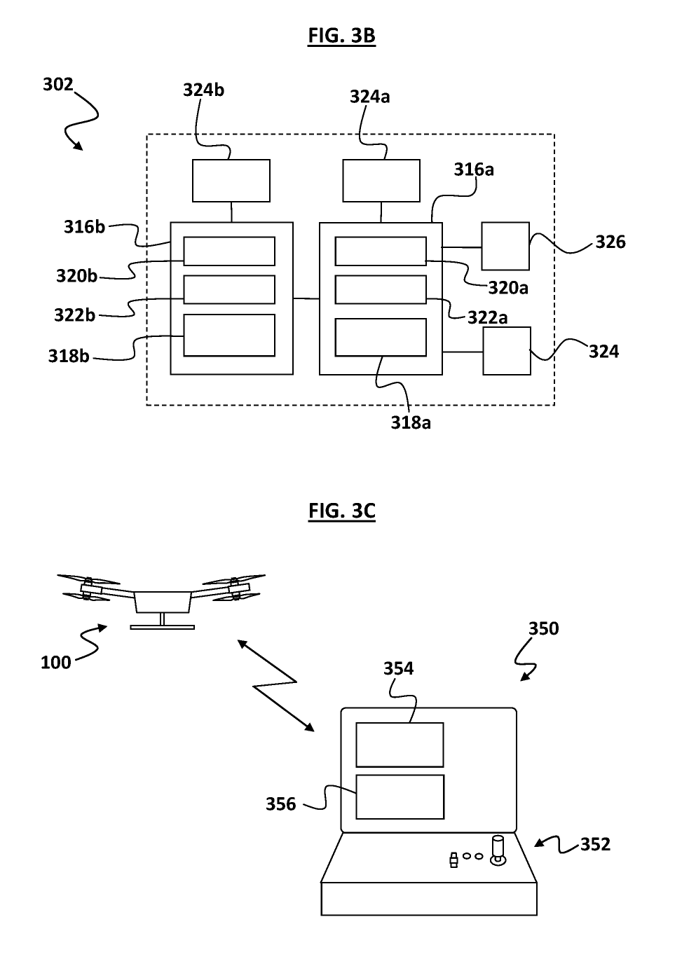

FIG. 3A illustrates an exemplary flight control system 300 for the UAV 100 or 200. The system 300 includes an on-board flight controller 302, controlling delivery of power from a battery 304 (for example, a lithium polymer battery) to the top motors 110a-d/210a-d and bottom motors 114a-d/214a-d via Electronic Speed Controllers (ESCs) 306a-h to control the speed and direction of the motors.

The system 300 includes GPS antennas 308a and 308b, as well as a radio frequency transceiver 310. A imaging device—for example a camera 312—is fitted to a controllable gimbal 314.

Referring to FIG. 3B, the flight controller 302 includes a master controller 316a and a slave controller 316b. Each controller 316a and 316b includes at least one microprocessor 318a and 318b, an inertial measurement unit 320a and 320b, and an onboard compass 322a and 322b. Each controller 316a and 316b are connected to respective GPS modules 324a and 324b. The master controller 316a is also connected to communications modules in the form of an RC receiver unit 324 and a wireless communications module 326 (for example using WiFi or Bluetooth).

While the flight controller 302 may allow for a number of automated flight modes and functions, the UAV 100 or 200 may communicate with a ground control unit 350, as seen in FIG. 3C. The ground control unit 350 includes user controls 352 for manual control of aspects of the UAV's operation, with a first display device 354 showing a live camera feed from camera 312, and a second display device 356 showing telemetry information.

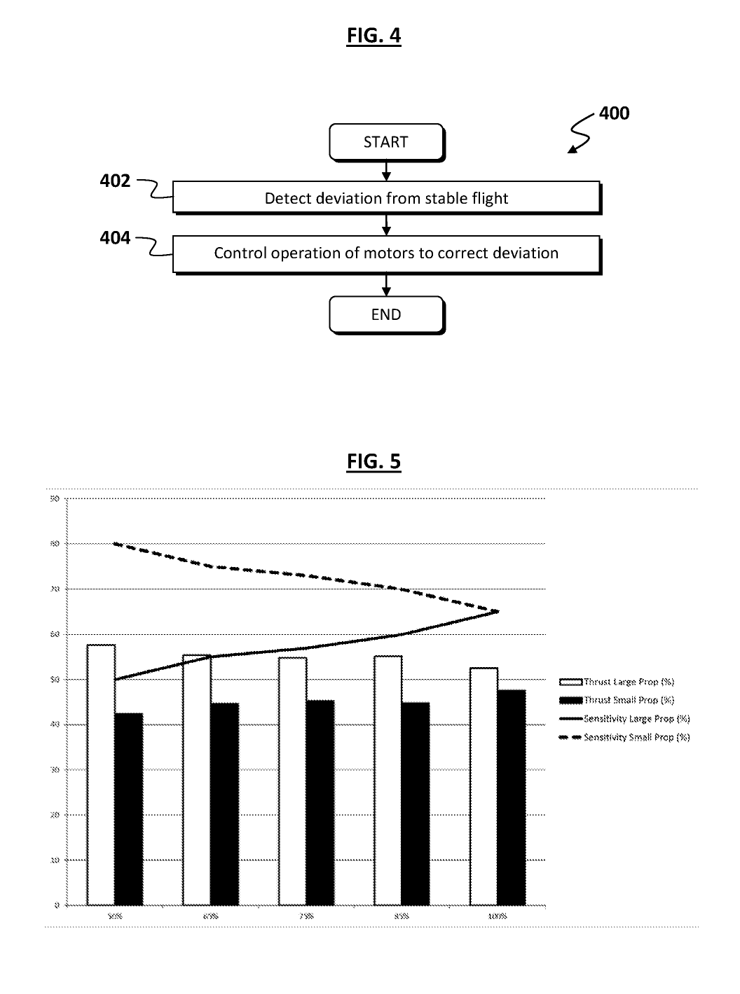

Referring to FIG. 4, the control system 302 is configured to stabilize the UAV 100 or 200 using a method 400 in which flight metrics such as yaw and pitch are monitored, and in response to determining that level flight is not being achieved in step 402, the controller proportionally controls the speed of the motors 110a-d/210a-d and 114a-d/214a-d in response in step 404.

In an exemplary embodiment, the top motors 110a-d/210a-d are controlled by a first feedback control loop having a first set of proportional control settings (for example PID values for each of the top motors 110a-d/210a-d), and the bottom motors 114a-d/214a-d are controlled by a second feedback control loop having a second set of proportional control settings (for example PID values for each of the bottom motors 114a-d/214a-d).

Tuning of the control settings may be performed by tuning the top motors 110a-d/210a-d separately from the bottom motors 114a-d/214a-d—i.e. tuning the top motors 110a-d/210a-d while the bottom motors 114a-d/214a-d are not running, and vice versa. Reference to tuning should be appreciated to mean adjusting the values of the PID parameters to achieve desired flight characteristics. By tuning the top and bottom motors separately, the control settings can be tailored to the distinct performance characteristics created by the differences in motor and propeller specifications.

It is envisaged that tuning may start from a general 60:40 thrust ratio distribution between the top motors 110a-d/210a-d separately from the bottom motors 114a-d/214a-d, with adjustments made in accordance with desired flight characteristics—for example, balancing power draw for flight time against sensitivity for stability.

An exemplary configuration of the sensitivity of the control of each motor pair—i.e. the extent to which motor speed is adjusted in response to deviations from stable flight—as well as the proportional contribution to total lift thrust at a number of throttle percentages is illustrated in FIG. 5. It may be seen that at 50% throttle—which in this case is intended to achieve hover flight of the UAV—the sensitivity of the smaller propeller/motor combination (expressed as a percentage of the maximum sensitivity setting capable by the control system 302) is proportionally much higher than that of the larger propeller/motor combination.

Reference to any prior art in this specification is not, and should not be taken as, an acknowledgement or any form of suggestion that that prior art forms part of the common general knowledge in the field of endeavor in any country in the world.

The disclosure may also be said broadly to consist in the parts, elements and features referred to or indicated in the specification of the application, individually or collectively, in any or all combinations of two or more of said parts, elements or features.

Wherein the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the disclosure and without diminishing its attendant advantages. It is therefore intended that such changes and modifications be comprised within the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various implementations other than those explicitly described are within the scope of the disclosure, and it should be appreciated that modifications and additions may be made thereto without departing from the scope thereof as defined in the appended claims.

1. A multirotor aircraft, including:
an airframe;
a plurality of rotor assemblies mounted to the airframe, each rotor assembly including:
a first motor having a first axis of rotation;
a first propeller connected to the first motor;
a second motor having a second axis of rotation;
a second propeller connected to the second motor, wherein the second propeller is smaller in length than the first propeller, and
wherein the first motor and the first propeller of each rotor assembly produce a greater proportion of a total lift thrust of the rotor assembly than the second motor and the second propeller of the rotor assembly.

2. The multirotor aircraft of claim 1, wherein the first motor and the first propeller of each rotor assembly are configured to produce between about 55 to 75 percent of the total lift thrust of the rotor assembly, and the second motor and the second propeller are configured to produce between about 45 to 25 percent of the total lift thrust.

3. The multirotor aircraft of claim 2, wherein the first motor and the first propeller of each rotor assembly are configured to produce between about 55 to 65 percent of the total lift thrust of the rotor assembly, and the second motor and the second propeller are configured to produce between about 45 to 35 percent of the total lift thrust.

4. The multirotor aircraft of claim 1, wherein the motor velocity constant of the first motor of each rotor assembly is smaller than that of the second motor of the rotor assembly.

5. The multirotor aircraft of claim 1, including a controller configured to control the first motors and second motors, wherein the first motors are controlled by a first control loop, and the second motors are controlled by a second control loop.

6. The multirotor aircraft of claim 1, wherein the first axis of rotation of the first motor of each rotor assembly is coaxial with the second axis of rotation with the second motor of the rotor assembly.

7. The multirotor aircraft of claim 1, wherein the first axis of rotation of the first motor of each rotor assembly is laterally offset from the second axis of rotation with the second motor of the rotor assembly.

8. The multirotor aircraft of claim 7, wherein the first motor and first propeller of each rotor assembly are positioned further from a centre of the airframe than the second motor and second propeller.

9. The multirotor aircraft of claim 8, wherein the airframe includes a plurality of booms to which the rotor assembles are mounted, and wherein the lateral offset between the first and second motors of each rotor assembly are achieved by spacing the motors apart along one of the booms.

10. The multirotor aircraft of claim 1, wherein the first motor and the first propeller of each rotor assembly are positioned above the second motor and the second propeller of the respective rotor assemblies.

11. The multirotor aircraft of claim 1, wherein the first motor and the second motor of each rotor assembly are configured to counter-rotate.

12. The multirotor aircraft of claim 1, wherein the first motor and the second motor of each rotor assembly are configured to rotate in the same direction.

13. The multirotor aircraft of claim 1, wherein the first propeller and the second propeller of each rotor assembly have a different number of blades.

14. The multirotor aircraft of claim 13, wherein the first propeller of each rotor assembly has more blades than the second propeller.

15. The multirotor aircraft of claim 15, wherein the first propeller has more than two blades.

16. The multirotor aircraft of claim 13, wherein the first propeller of the rotor assembly is a three blade propeller, and the second propeller is a two blade propeller.

17. A rotor assembly for a multirotor aircraft, including:
a first motor having a first axis of rotation;
a first propeller connected to the first motor;
a second motor having a second axis of rotation;
a second propeller connected to the second motor, wherein the second propeller is smaller in length than the first propeller, and
wherein the first motor and the first propeller produce a greater proportion of a total lift thrust of the rotor assembly than the second motor and the second propeller.

18. A method of operating a multirotor aircraft including an airframe, and a plurality of rotor assemblies mounted to the airframe, each rotor assembly including a first motor having a first axis of rotation with a first propeller connected to the first motor, and a second motor having a second axis of rotation and a second propeller connected to the second motor, wherein the second propeller is smaller in length than the first propeller, the method including the step of:
controlling the first motor and the second motor of each rotor assembly such that the first motor and the first propeller produce a greater proportion of a total lift thrust of the rotor assembly than the second motor and the second propeller of the rotor assembly.
